(19) United States
(12) Patent Application Publication
(10) Pub. No.: US 2009/0168238 A1
(43) Pub. Date: Jul. 2, 2009

(54) INFORMATION STORAGE MEDIUM USING FERROELECTRIC, METHOD OF MANUFACTURING THE SAME, AND INFORMATION STORAGE APPARATUS INCLUDING THE SAME

(75) Inventors: Yong-kwan KIM, Yongin-si (KR); Dae-hong KIM, Pohang-si (KR); Sung-gi BAIK, Pohang-si (KR); Seung-bum HONG, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignees: SAMSUNG ELECTRONICS CO., LTD, Suwon-si (KR); POHANG UNIVERSITY OF SCIENCE AND TECHNOLOGY, Pohang-si (KR)

(21) Appl. No.: 12/166,374

(22) Filed: Jul. 2, 2008

(30) Foreign Application Priority Data
Jan. 2, 2008 (KR) 10-2008-0000164

(51) Int. Cl. G11B 5/127; G11B 5/74; B05D 5/12

(52) U.S. Cl. 360/110; 360/131; 427/126.3

(57) ABSTRACT

Provided is an information storage medium using a ferroelectric, including a substrate having an amorphous crystal structure, an electrode layer formed on the substrate, and a ferroelectric layer in a (001) direction formed on the electrode layer.

### CROSS-REFERENCE TO RELATED PATENT APPLICATION

This application claims priority from Korean Patent Application No. 10-2008-0000164, filed on Jan. 2, 2008, in the Korean Intellectual Property Office, the disclosure of which is incorporated herein in its entirety by reference.

### BACKGROUND OF THE INVENTION

1. Field of the Invention

Apparatuses and methods consistent with the present invention relate to an information storage medium using a ferroelectric, a method of manufacturing the same, and an information storage apparatus including the same, and more particularly, to an information storage medium including an amorphous substrate designed to provide excellent ferroelectric properties, a method of manufacturing the information storage medium, and an information storage apparatus including the same.

2. Description of the Related Art

Hard disk drives (HDDs) are auxiliary memory devices designed to store data on a disc-like aluminum substrate typically coated with a magnetic material. HDDs are data storage technologies that have already established strong positions in the memory market. Over the past several decades, a drive mechanism for HDDs has become the most advanced technology among mechanical devices. However, a decrease in growth rate of area recording density has presented a challenge to the HDD industry.

To solve this challenge, research has been intensively conducted on next-generation technologies such as Patterned Media, Heat-Assisted Magnetic Recording (HAMR), and probe-based data storage. A probe for data storage was developed to meet the growing demand for small, high capacity data storages. IBM's Millipede probe-based data storage uses an array of thousands of probe heads to linearly move a media under the numerous probe heads for read/write operation.

For the probe-based data storage, a writing signal is applied independently to each of the numerous probe heads during writing operation. Similarly, a read signal from each probe is handled independently during reading. In order to overcome this inconvenience or complication, there is a need to develop a ferroelectric HDD using both drive mechanism of HDD and ferroelectric media as well as a method of manufacturing the ferroelectric media.

Related art ferroelectric media may have different structures depending on the type of a substrate used. A ferroelectric media using a silicon (Si) substrate requires a multi-layered structure for forming a ferroelectric layer. The ferroelectric media also requires laser machining or dry etching steps during its manufacturing for use in an HDD system, thereby resulting in high manufacturing costs, i.e., low price competitiveness. Similarly, a ferroelectric media using a single crystal substrate may degrade price competitiveness because of the high cost of the substrate caused by an increase in the area occupied by a ferroelectric layer. Despite its large substrate area and high price competitiveness, a ferroelectric media using an amorphous substrate such as glass substrate also has a drawback that it is difficult to form a ferroelectric layer having excellent ferroelectric properties on the amorphous substrate. Therefore, there is an urgent need for a ferroelectric media having a low-cost structure that can provide excellent ferroelectric properties and a technique for manufacturing the ferroelectric media.

### SUMMARY OF THE INVENTION

Exemplary embodiments of the present invention address at least the above problems and/or disadvantages and other disadvantages not described above. Also, the present invention is not required to overcome the disadvantages described above, and an exemplary embodiment of the present invention may not overcome any of the problems described above.

The present invention provides an information storage medium including an amorphous substrate and a ferroelectric layer having excellent ferroelectric properties, a method of manufacturing the information storage medium, and an information storage apparatus including the same.

According to an aspect of the present invention, there is provided an information storage medium, including a substrate having an amorphous crystal structure, an electrode layer disposed on the substrate, and a ferroelectric layer in the (001) direction disposed on the electrode layer.

The substrate may be formed of glass, amorphous silicon, or Al. The ferroelectric layer may be formed of Pb(Zr,Ti)O₃(PZT), (Pb,La)TiO₃(PLT), PbTiO₃, PbZrO₃, KNbO₃, LiTaO₃, LiNbO₃, or BiFeO₃. The electrode layer may be formed of a material Pt, Al, Au, Ag, Cu, Ir, IrO₂, SrRuO₃, or (La,Sr)CoO.

The information storage medium may further include an underlayer that is disposed between the substrate and the electrode layer and has a lattice length that is comparable to lattice lengths of the electrode layer and the ferroelectric layer. The medium may further include a seed layer that is disposed between the underlayer and the substrate and induces orientation growth of the underlayer in the (00l) direction where l is a natural number. The underlayer may be formed of Cr or Fe.

The seed layer may be formed of Ta or Zr. The underlayer may have a thickness of 10 to 100 nm. The medium may further include a protective layer that is disposed on the ferroelectric layer and prevents damage to the ferroelectric layer.

According to another aspect of the present invention, there is provided an information storage apparatus including: an information storage medium including a substrate having an amorphous crystal structure, an electrode layer disposed on the substrate, and a ferroelectric layer in the (001) direction disposed on the electrode layer; and a read/write head facing the ferroelectric layer in the information storage medium and reading and/or writing information from and/or to the ferroelectric layer.

According to another aspect of the present invention, there is provided a method of manufacturing an information storage medium, including: forming an electrode layer on a substrate having an amorphous crystal structure; and forming a ferroelectric layer in the (001) direction on the electrode layer. The ferroelectric layer may be formed of Pb(Zr,Ti)O₃(PZT), (Pb,La)TiO₃(PLT), PbTiO₃, PbZrO₃, KNbO₃, LiTaO₃, LiNbO₃, or BiFeO₃. The ferroelectric layer may be formed by sputtering in an oxygen atmosphere under a pressure of 10 to 200 mTorr at a temperature of 450 to 650° C. The substrate may be formed of glass, amorphous silicon, or Al.

The method may further include forming an underlayer between the substrate and the electrode layer, which has a lattice length that is comparable to lattice lengths of the electrode layer and the ferroelectric layer. The method may further include forming a seed layer between the underlayer and the substrate so as to induce orientation growth of the underlayer in the (00l) direction where l is a natural number. The seed layer may be formed of Ta or Zr and the underlayer may be formed of Cr or Fe. Alternatively, the seed layer and the underlayer may be formed of Ta and Cr, respectively. The method may further include forming a protective layer on the ferroelectric layer so as to prevent damage to the ferroelectric layer.

### BRIEF DESCRIPTION OF THE DRAWINGS

The above and other aspects of the present invention will become more apparent by describing in detail exemplary embodiments thereof with reference to the attached drawings in which:

FIG. 1 illustrates a schematic structure of an information storage apparatus according to an exemplary embodiment of the present invention;

FIG. 2 is a cross-sectional view of an information storage medium in the information storage apparatus of FIG. 1;

FIG. 3 is a graph illustrating the crystallinity of a chrome (Cr) layer grown on a tantalum (Ta) layer as measured by X-ray diffraction (XRD);

FIG. 4A illustrates the crystal structure of a (002) plane in a Cr layer;

FIG. 4B illustrates the crystal structure of a (002) plane in a platinum (Pt) layer;

FIG. 4C illustrates the crystal structure of a (001) plane in a lead titanium oxide (PbTiO₃) layer;

FIG. 4D illustrates a structure in which a Pt layer in the (002) direction and a PbTiO₃ layer in the (001) direction have been rotated by 45° and sequentially stacked on a Cr layer in the (002) direction; and

FIGS. 5A through 5D illustrate steps in a method of manufacturing an information storage medium according to an exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown. The invention should not be construed as being limited to the exemplary embodiments set forth herein; rather, these exemplary embodiments are provided so that this disclosure will fully convey the concept of the invention to those skilled in the art. In the drawings, the thicknesses of layers and regions are exaggerated for clarity. Like reference numerals in the drawings denote like elements, and thus their description will be omitted.

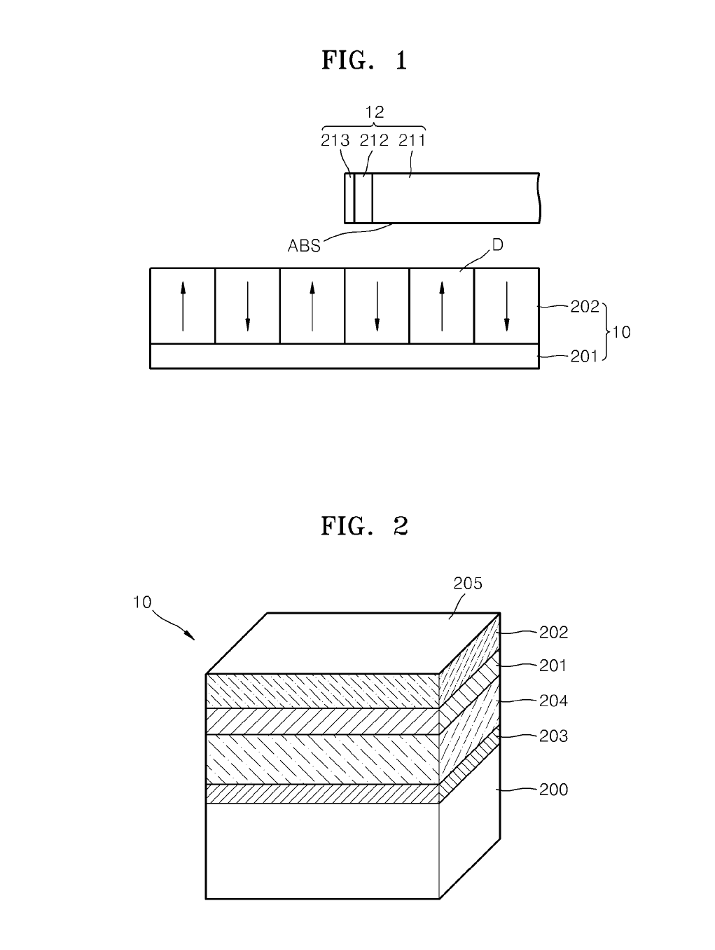

FIG. 1 illustrates a schematic structure of an information storage apparatus according to an exemplary embodiment of the present invention. Referring to FIG. 1, the information storage apparatus according to the present exemplary embodiment includes a ferroelectric media 10 that is an information storage media and a read/write head 12 that is disposed above the ferroelectric media 10, preferably, but not necessarily, at a location on the ferroelectric media 10 facing a ferroelectric layer 202 that will be described later and reads and/or writes information from/to the ferroelectric media 10.

The read/write head 12 and the ferroelectric media 10 moves relative to each other. For example, like a hard disk in a related art magnetic recording hard disk drive (HDD), the ferroelectric media 10 may have a rotating disk-shaped surface. Similar to the related art HDD, the read/write head 12 is mounted on an end of a swing arm (not shown) rotated by a voice coil motor (not shown), preferably, on a suspension arm (not shown) attached to the end of the swing arm so as to move across annular tracks.

The ferroelectric media 10 is an information storage media from or to which information is read or written and includes an electrode layer 201 and a ferroelectric layer 202. The ferroelectric layer 202 may have ferroelectric materials stacked in the (001) direction. Ferroelectric materials possess a spontaneous polarization or electric dipole moment, the direction of which can be switched by application of an external electric field. In the information storage apparatus of FIG. 1, a write head 213 in the read/write head 12 writes information such that dipoles in a domain D that is a basic information unit in the ferroelectric layer 202 can have “up” or “down” polarization direction. The read head 212 detects the polarization direction of the domain D in the ferroelectric layer 202 to reproduce information.

More specifically, the read/write head 12 includes the read write 212 and the write head 213 disposed on one surface of an insulating layer 211. For example, the read head 212 may include a semiconductor material that is affected by an electric field in the domain D according to the polarization of the domain D to change a resistance value and read information recorded on the ferroelectric media 10 according to the change in resistance value. As shown in FIG. 1, the write head 213 can write information to the domain D with application of a voltage, which is greater than the absolute value of a critical voltage that induces polarization, to the ferroelectric layer 202. An “ABS” in FIG. 1 is an abbreviation of an air bearing surface designed to suspend the read/write head 12 from above the surface of the ferroelectric media 10. Since the ABS has been used in a related art magnetic recording HDD, a detailed description thereof will not be given.

FIG. 2 is a cross-sectional view of the ferroelectric media 10 in the information storage apparatus of FIG. 1. Referring to FIG. 2, the electrode layer 201 and the ferroelectric layer 202 are disposed on a substrate 200 having an amorphous crystal structure. The substrate 200 may be formed of an amorphous material having no crystal lattice, such as glass, amorphous silicon (Si), or aluminum (Al).

The electrode layer 201 may be formed of a conductive material that can be typically used in a semiconductor memory device or oxide containing the conductive material. For example, the electrode layer 201 may be formed of a metallic material such as platinum (Pt), Al, gold (Au), silver (Ag), copper (Cu) or iridium (Ir), or metal oxide such as iridium oxide (IrO₂), strontium-ruthenium-oxide (SrRuO₃) or lanthanum strontium cobalt oxide ((La,Sr)CoO). The electrode layer 201 may have a thickness of 10 to 100 nm.

For a related art magnetic recording information storage media, a magnetic material loses all of its magnetic properties when heated above a certain temperature. As a data recording area decreases, the amount of a magnetic material used to record one bit decreases. When the amount of magnetic material is reduced below a certain level, thermal stability rapidly drops. This phenomenon is called a thermal relaxation effect or superparamagnetic effect. A superparamagnetic effect causes changes in the magnetization direction of a magnetic material with a small amount of heat. Consequently, this instability causes the magnetization direction to randomly fluctuate. In other words, data stored on the media will begin to decay. Thus, the superparamagnetic effect imposes a barrier to increasing recording density. However, when the ferroelectric media 10 having the ferroelectric layer 202 is used as an information storage media according to the present invention, the ferroelectric media 10 does not suffer from a superparamagnetic effect even when a bit or domain size decreases, thereby achieving high recording density. The ferroelectric layer 202 may be formed of a ferroelectric material such as Pb(Zr,Ti)O₃(PZT), (Pb,La)TiO₃(PLT), PbTiO₃, PbZrO₃, KNbO₃, LiTaO₃, LiNbO₃, or BiFeO₃. The ferroelectric layer 202 may have a thickness of less than 50 nm. In order to maximize the ferroelectric properties, the above ferroelectric materials may be formed in the (001) direction.

When the substrate 200 is formed of a single crystal material, it is easy to epitaxially grow the ferroelectric layer 202 in the (001) direction. A single crystal substrate is more expensive to produce than an amorphous substrate. Thus, to obtain the ferroelectric layer 202 grown in the (001) direction by using the amorphous substrate 202, a material layer is needed to induce orientation growth of the ferroelectric layer in the (001) direction. The material layer is required to have little lattice mismatch between the ferroelectric layer 202 and the electrode layer 201.

To achieve this purpose, referring to FIG. 2, the ferroelectric media 10 may further include an underlayer 204 that is interposed between the substrate 200 and the electrode layer 201 and induces formation of the ferroelectric layer 202 and the electrode layer 201 in the desired orientation. The underlayer 204 may have a thickness of 10 to 100 nm. The underlayer 204 may be a metal layer grown in the (00l) direction. For example, the underlayer 204 may be a Cr or Fe layer in the (00l) direction where l is a natural number (i.e., 1, 2, 3, . . . ).

The ferroelectric media 10 further includes a seed layer 203 disposed between the substrate 200 and the underlayer 204. For example, the underlayer 204 may be grown toward the direction in which the surface energy is most stable, other than the (00l) direction. In this case, the underlayer 204 may be grown in the desired (00l) direction by adjusting the growth process conditions. However, the process conditions may not be sufficient so that the underlayer 204 can be highly oriented in the (00l) direction. According to the present invention, the seed layer 203 not only induces stable growth of the underlayer 204 in the (00l) direction but also improves wettability of the underlayer 204 so as to increase smoothness. For example, the seed layer 203 may be formed of tantalum (Ta) or zirconium (Zr) to a thickness of less than 10 nm.

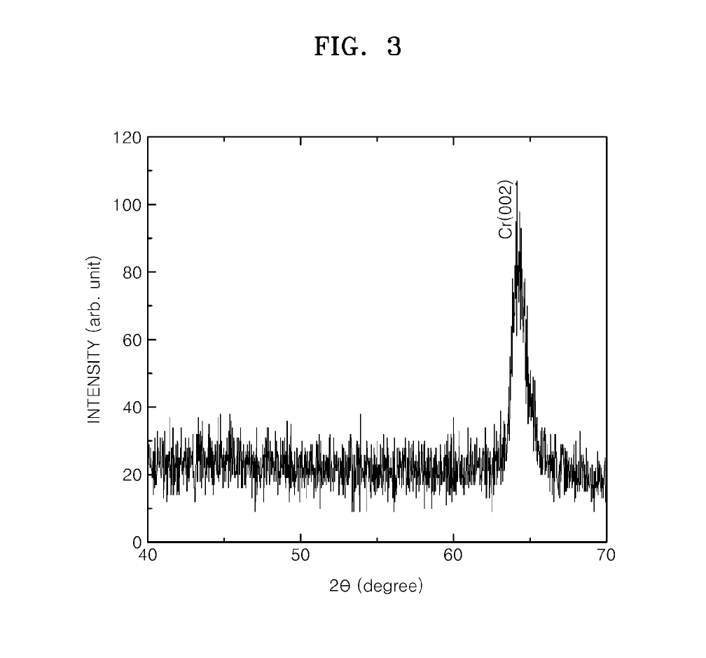

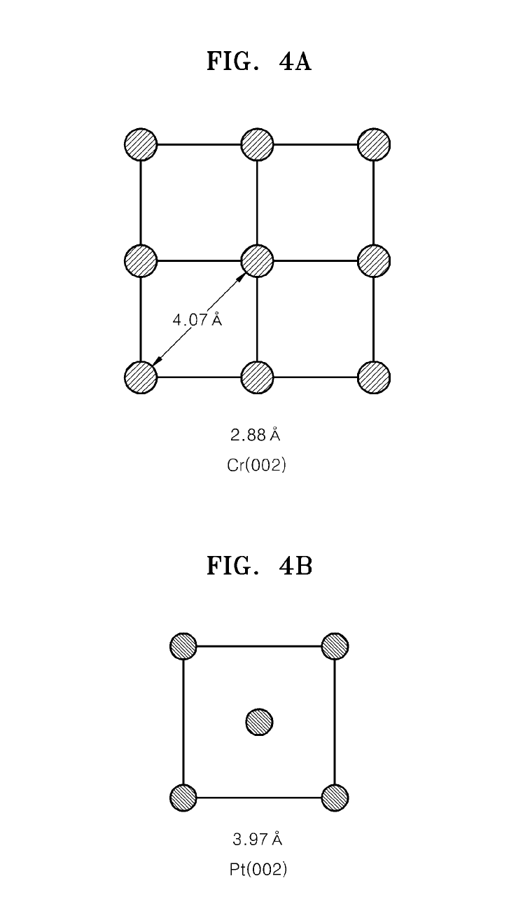

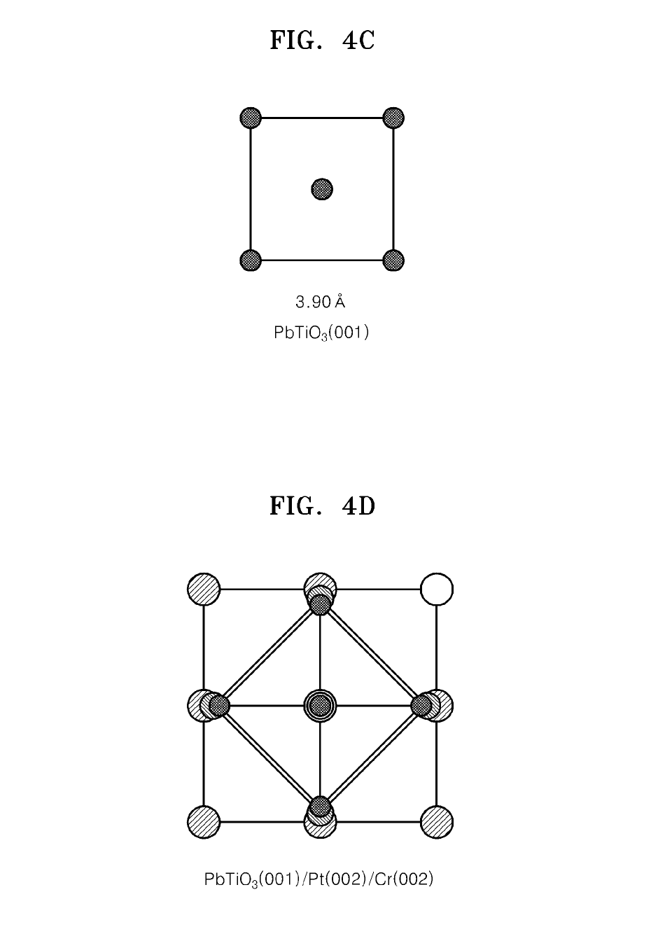

It is assumed herein that a Ta layer (seed layer 203), a Cr layer (underlayer 204), a Pt layer (electrode layer 201), and a PbTiO₃ layer (ferroelectric layer 202) are sequentially formed on a glass substrate (substrate 200). FIG. 3 is a graph illustrating the crystallinity of the Cr layer as measured by X-ray diffraction (XRD). In this case, the Cr layer is formed on the Ta layer to a thickness of 100 nm. Referring to FIG. 3, the Cr layer is grown in the (002) direction. FIG. 4A illustrates the crystal structure of a (002) plane in the Cr layer. FIG. 4B illustrates the crystal structure of a (002) plane in the Pt layer and FIG. 4C illustrates the crystal structure of a (001) plane in the PbTiO₃ layer. Referring to FIGS. 4A through 4C, a diagonal lattice spacing of the Cr layer in the (002) direction, a lattice spacing of the Pt layer in the (002) direction, and a lattice spacing of the PbTiO₃ layer in the (001) direction are about 4.07 Å, 3.97 Å, and 3.90 Å, respectively, which are very close to one another. Thus, when the Pt layer in the (002) direction and the PbTiO₃ layer in the (001) direction are rotated by 45° and sequentially stacked on the Cr layer in the (002) direction, the three-layer stack structure has little lattice mismatch as shown in FIG. 4D. In this way, the ferroelectric layer 202 grown in the (001) direction can be obtained using the amorphous substrate 200.

The ferroelectric media 10 further includes a protective layer 205 disposed on the surface of the ferroelectric layer 202 so as to prevent damage to the ferroelectric layer 202. The protective layer may be formed of either or both diamond like carbon (DLC) and lubricant that can be used on the surface of typical hard disks.

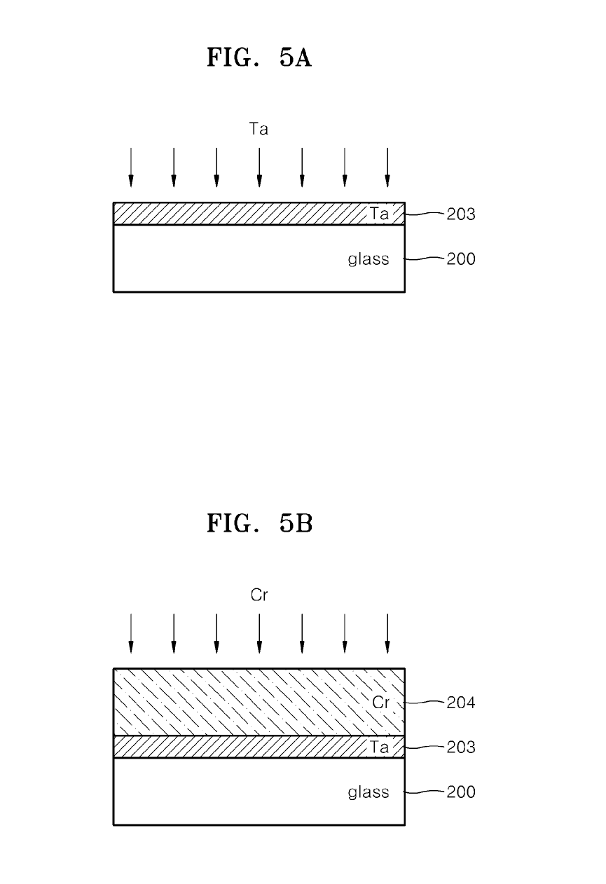

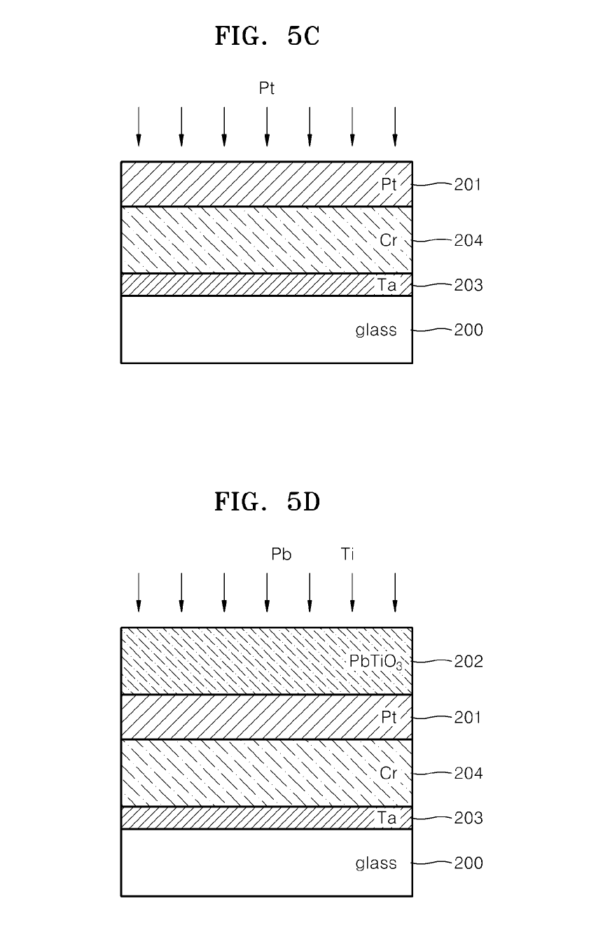

FIGS. 5A through 5D illustrate steps in a method of manufacturing an information storage media according to an exemplary embodiment of the present invention.

Referring to FIG. 5A, an amorphous substrate 200 is prepared. As described above, the substrate 200 may be formed of glass, amorphous Si, or Al. In the present exemplary embodiment, the substrate 200 is a glass substrate. First, a seed layer 203 is formed by sputtering Ta on the substrate 200. More specifically, the Ta seed layer 203 is formed on the substrate 200 to a thickness of about 5 nm in an argon atmosphere under a pressure of 10 to 20 mTorr at room temperature at RF power of 1 to 100 W. The Ta seed layer 203 may have an amorphous or crystalline structure.

Referring to FIG. 5B, in the present exemplary embodiment, an underlayer 204 is subsequently formed by sputtering Cr on the seed layer 203. More specifically, the Cr underlayer 204 is formed on the seed layer 203 to a thickness of about 100 nm in an argon atmosphere under a pressure of 1 to 10 mTorr at room temperature to 400° C. at RF power of 1 to 60 W. Since the seed layer 203 induces orientation growth of a Cr layer in the (002) direction, the Cr underlayer 204 in the (002) direction is formed on the seed layer 203. The seed layer 203 also improves wettability of the underlayer 204 so as to increase the smoothness thereof.

Referring to FIG. 5C, in the present exemplary embodiment, an electrode layer 201 is formed by sputtering Pt on the underlayer 204. More specifically, the Pt electrode layer 201 is formed on the underlayer 204 to a thickness of about 50 nm in an argon atmosphere under a pressure of 1 to 20 mTorr at room temperature to 500° C. at RF power of 1 to 50 W. Since the Cr underlayer 204 in the (002) direction induces orientation growth of a Pt layer along the (002) direction, the Pt electrode layer 201 in the (002) direction is rotated by 45° and disposed on the underlayer 204.

Referring to FIG. 5D, according to the present exemplary embodiment, a ferroelectric layer 202 is formed by sputtering Pb, Ti, or a compound thereof on the electrode layer 201. More specifically, the PbTiO₃ ferroelectric layer 202 is formed on the electrode layer 201 to a thickness of about 40 nm in an oxygen atmosphere under a pressure of 10 to 200 mTorr at a temperature of 450 to 650° C. at RF power of 1 to 50 W. Since the Pt electrode layer 201 in the (002) direction induces orientation growth of a PbTiO₃ layer along the (001) direction, the PbTiO₃ ferroelectric layer 202 epitaxially grown in the (001) direction is rotated by 45° and disposed on the electrode layer 201.

Although not shown in FIGS. 5A through 5D, a protective layer is formed of both or either of DLC and lubricant. Since formation of the protective layer is performed in the same manner as in a method of manufacturing a hard disk for use in a related magnetic recording HDD, a detailed description thereof will not be given.

The manufacturing method according to the present exemplary embodiment can obtain the ferroelectric layer 202 that is epitaxially grown on the low-price amorphous substrate 200 along the (001) direction in which ferroelectric properties are maximized. The use of the seed layer 203 allows highly oriented growth of the underlayer 204 in the desired direction, thereby improving smoothness of the media.

While an information storage medium using a ferroelectric according to the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An information storage medium comprising:
a substrate having an amorphous crystal structure;
an electrode layer disposed on the substrate; and
a ferroelectric layer in a (001) direction disposed on the electrode layer.

2. The medium of claim 1, wherein the substrate is formed of a material selected from the group consisting of glass, amorphous silicon and Al.

3. The medium of claim 1, wherein the ferroelectric layer is formed of a material selected from the group consisting of Pb(Zr,Ti)O₃(PZT), (Pb,La)TiO₃(PLT), PbTiO₃, PbZrO₃, KNbO₃, LiTaO₃, LiNbO₃ and BiFeO₃.

4. The medium of claim 1, wherein the electrode layer is formed of a material selected from the group consisting of Pt, Al, Au, Ag, Cu, Ir, IrO₂, SrRuO₃ and (La,Sr)CoO.

5. The medium of claim 1, further comprising an underlayer that is disposed between the substrate and the electrode layer and has a lattice length that is comparable to lattice lengths of the electrode layer and the ferroelectric layer.

6. The medium of claim 5, further comprising a seed layer that is disposed between the underlayer and the substrate and induces orientation growth of the underlayer in the (00l) direction, where l is a natural number.

7. The medium of claim 6, wherein the underlayer is formed of Cr or Fe.

8. The medium of claim 7, wherein the seed layer is formed of Ta or Zr.

9. The medium of claim 5, wherein the underlayer has a thickness of 10 to 100 nm.

10. The medium of claim 1, further comprising a protective layer that is disposed on the ferroelectric layer.

11. A method of manufacturing an information storage medium, the method comprising:
forming an electrode layer on a substrate having an amorphous crystal structure; and
forming a ferroelectric layer in a (001) direction on the electrode layer.

12. The method of claim 11, wherein the ferroelectric layer is formed of a material selected from the group consisting of Pb(Zr,Ti)O₃(PZT), (Pb,La)TiO₃(PLT), PbTiO₃, PbZrO₃, KNbO₃, LiTaO₃, LiNbO₃ and BiFeO₃.

13. The method of claim 11, wherein the ferroelectric layer is formed by sputtering in an oxygen atmosphere under a pressure of 10 to 200 mTorr at a temperature of 450 to 650° C.

14. The method of claim 11, wherein the substrate is formed of a material selected from the group consisting of glass, amorphous silicon and Al.

15. The method of claim 11, further comprising forming an underlayer between the substrate and the electrode layer, the underlayer having a lattice length that is comparable to lattice lengths of the electrode layer and the ferroelectric layer.

16. The method of claim 15, further comprising forming a seed layer between the underlayer and the substrate so as to induce orientation growth of the underlayer in the (00) direction, where l is a natural number.

17. The method of claim 16, wherein the seed layer is formed of Ta or Zr, and
wherein the underlayer is formed of Cr or Fe.

18. The method of claim 17, wherein the seed layer and the underlayer are formed of Ta and Cr, respectively.

19. The method of claim 11, further comprising forming a protective layer on the ferroelectric layer.

20. An information storage apparatus comprising:
an information storage medium which comprises a substrate having an amorphous crystal structure, an electrode layer disposed on the substrate, and a ferroelectric layer in a (001) direction disposed on the electrode layer; and
a read/write head which faces the ferroelectric layer in the information storage medium, and reads or writes information from or to the ferroelectric layer.

21. The apparatus of claim 20, wherein the ferroelectric layer is formed of a material selected from the group consisting of Pb(Zr,Ti)O₃(PZT), (Pb,La)TiO₃(PLT), PbTiO₃, PbZrO₃, KNbO₃, LiTaO₃, LiNbO₃, and BiFeO₃.

22. The apparatus of claim 20, wherein the electrode layer is formed of a material selected from the group consisting of Pt, Al, Au, Ag, Cu, Ir, IrO₂, SrRuO₃ and (La,Sr)CoO.

23. The apparatus of claim 20, wherein the information storage medium further comprises an underlayer that is disposed between the substrate and the electrode layer and has a lattice length that is comparable to lattice lengths of the electrode layer and the ferroelectric layer.

24. The apparatus of claim 23, wherein the information storage medium further comprises a seed layer that is disposed between the underlayer and the substrate and induces orientation growth of the underlayer in the (00l) direction, where l is a natural number.
